(19) United States
(12) Patent Application Publication
(10) Pub. No.: US 2011/0167332 A1
(43) Pub. Date: Jul. 7, 2011

(54) System and Method for Generating Web Pages

(75) Inventor: George Demosthenes Nickas, JR., Austin, TX (US)

(73) Assignee: Neopost Technologies, Bagneux (FR)

(21) Appl. No.: 12/683,543

(22) Filed: Jan. 7, 2010

(51) Int. Cl. G06F 17/00

(52) U.S. Cl. 715/234

(57) ABSTRACT

A page resource builder provides an interface between development source files and a production Web page or other compiled file. The page resource builder may identify components in the source files and compile them into production files, each of which includes only those components used by the production Web page. The production files also may exclude components not used by the production files. Production files generated by the page resource builder may allow for a production Web page to be downloaded with a minimum of request/response exchanges between an end user Web browser and a Web server.

### CROSS REFERENCE TO RELATED APPLICATIONS

The present application is related to U.S. patent application Ser. No. ______, attorney docket number 26978A-018900US, filed concurrently herewith, the contents of which are incorporated by reference herein in their entirety.

### BACKGROUND OF THE INVENTION

Modern, complex Web pages can provide a range of content and functionality, from plain text and images to interactive, full-featured applications. To do so, complex Web pages include multiple scripting, style definition, and other files, such as JavaScript, Cascading Style Sheet (CSS) definitions, and other file types. Often, these files include one or more links or dependencies to other files. For example, a Web page may include a link to a JavaScript file that includes certain functionality for the page. The linked JavaScript file may, in turn, link to one or more other JavaScript files that provide further functionality that complements functionality provided by the first file. Such arrangements are commonly used to reduce the development effort required to construct the Web pages, or in concert with segmented development techniques. Web pages often suffer a performance penalty proportional to how many of these files are included on the page, since each file usually requires a request from the end user to a Web server, and an associated reply with the corresponding file. If network latency is relatively high, this can be a large penalty since the user cannot effectively interact with the Web page until all of the files referenced within the page have been downloaded to a browser. Many requests for a single Web page also increases Web server load and an amount of network bandwidth used.

Thus, loading time and performance of a complex Web page are commonly affected by two main factors: a latency between the user and a server providing the Web page, and an available bandwidth associated with the transfer of the Web page to the end user. Latency generally refers to a round-trip time required for the end user to request and receive a file associated with the Web page. The available bandwidth generally refers to a speed at which data may be transferred between the end user and the provider (Web server) of the Web page.

### BRIEF SUMMARY OF THE INVENTION

According to embodiments of the invention, a page resource builder may provide an interface between development source files and a production Web page. The page resource builder may identify components used in the development source files and compile them into one or more production files, each of which may include all the components of a particular type used by the production Web page, and may include only those components used by the Web page. A production Web page generated by a page resource builder may allow for a production Web page to be downloaded with a minimum of request/response exchanges between an end user Web browser and a Web server.

In an embodiment, a computer-implemented method according to the invention may include identifying components within a Web page source file, each component being a script function, a style definition, or an image; for each identified component, generating an opening tag for the component, the opening tag identifying a name of the component and any other components on which the identified component depends, and modifying the Web page source file to include the opening tag at a location preceding a beginning of the component; for each identified component, generating a closing tag for the component, and modifying the Web page source file to include the closing tag at a location following an end of the component; identifying components within a development source file used to generate a production Web page, the development source file providing a development version of the production Web page; for each component identified in the development source file: (1) selecting a linked file based on whether the component is a script function, a style definition, or an image, the linked file being used during rendering of the production Web page; and (2) copying the component from the Web page source file to the selected linked file; generating a main Web page file containing hypertext markup language to render the production Web page and a link to each of the linked file to which a component is copied; and responsive to a request for the production Web page, providing the main Web page file to a Web browser of an end user. The Web page source file may be or include a library of components and/or may include the development source file. The set of selected linked files may include a script file consisting essentially of the script functions required by the production Web page and/or a style definition file consisting essentially of the style definitions required by the production Web page. The identified components used to generate the production Web page may include a plurality of images, in which case the method may include generating a single image file containing each of the plurality of images identified in the development source file; generating a style definition indicating a location of each image within the single image file; and adding the generated style definition to the linked file selected for style definition components. The linked file selected for style definition components may include, or may only include, all of the style information required to render the production Web page. The set of linked files selected may include, or may only include, of a script function file, a style definition file, and an image file. The main Web page file and the linked files may contain all the HTML, script, style, and image data required to render the production Web page, and the selected linked files may include only the script, style, or image data required to render the production Web page. The method may further include providing a selected linked file responsive to a request from the end user Web browser. The production Web page may be provided to the end user Web browser in response to no more than four requests.

In an embodiment, a computer-implemented method according to the invention may include identifying resource tags within a development source file, the development source file providing a development version of a production Web page and each resource tag identifying a component used to generate the production Web page; for each identified resource tag: (1) identifying the corresponding component used to generate the production Web page; (2) identifying the type of the identified component; (3) copying each identified component from the development source file to a linked file designated for components of the same type as the identified component, the linked file providing all the components of a single type required to render the production Web page; generating a main Web page file containing hypertext markup language to render the production Web page and a link to each linked file to which a component is copied; and responsive to a request for the production Web page, providing the main Web page file to a Web browser of an end user. The set of linked files to which components are copied may include a first linked file containing all the script components required to render the production Web page and a second linked file containing all the style definitions required to render the production Web page. It also may include a third linked file containing all the images required to render the production Web page. The first linked file may include or may only include script components required to render the production Web page, and the second linked file consists essentially of style definitions required to render the production Web page. The set of linked files to which components are copied may include a third linked file, which may include or may only include all the images required to render the production Web page.

### BRIEF DESCRIPTION OF THE DRAWINGS

FIG. 1 shows an example data flow used with a page resource builder according to an embodiment of the invention.

FIG. 2 shows an example data flow associated with a page resource builder according to an embodiment of the invention.

FIG. 3 shows an example computer-implemented process for automatically adding PRB tags to a library file.

FIG. 4 shows an example process for using a page resource builder according to an embodiment of the invention.

FIG. 5 shows a specific example of a system and data flows according to an embodiment of the invention.

FIG. 6 shows a computer suitable for use with embodiments of the present invention.

FIG. 7 shows a schematic diagram of a processing unit suitable for use with embodiments of the present invention.

FIG. 8 shows an example of a computer network 70 suitable for use with the present invention.

### DETAILED DESCRIPTION OF THE INVENTION

As used herein, and as understood by one of skill in the art, when a first file is described as “including” a second file, contents of the second file may be duplicated within the first file, or a link to the second file may be included in the first file. As a specific example, an HTML file may “include” a JavaScript file by way of an appropriate tag, typically an HTML “script” tag. Generally, a file referenced by another file by way of a link will be downloaded by an end user Web browser by way of a separate request to the Web server. In contrast, if the contents of the second file are duplicated in the first, no subsequent request is necessary to obtain the second file contents. Unless specifically indicated otherwise, when a second file is “included in” a first file, the contents of the second file are duplicated within the first file. As used herein, when a first file “links to” or “includes a link to” a second file, the contents of the second file are not copied or otherwise directly included in the first file. Rather, a “linked” file remains a separate file that is referenced via an appropriate tag or link, such as the HTML script tag described above.

To reduce bandwidth-influenced load time, developers often remove content including Web page functionality, or reduce a quality of presentation, such as by using a limited number of graphics. To reduce latency-influenced load time, developers often develop the page by combining and loading functional groups of blocks together as required for a particular Web page. The groups also may be compressed to further reduce bandwidth. However, since the functional groups are created artificially, subsequent developers may encounter difficulty in modifying or operating a specific Web page to function differently from the original page, as developed with the originally-defined functional groups. For example, adding functionality that spans multiple groups, or that does not fit directly into the definitions used to initially generate the groups, may be undesirably complex due to the original functional groupings.

Developers may encounter additional difficulty when attempting to use a page that has been bandwidth- and/or latency-optimized as a template for a similar, but non-trivially different page. For example, a first page, which is to be used as a template, may be developed using one set of function and functional blocks that simplify development of the first page. During optimization, additional or different functional blocks are removed. Thus, when creating a second page that is substantially similar to the first, development effort will necessarily be duplicated since some functionality is removed during the optimization process. As a specific example, when optimizing a Web page to increase performance, the overall code quality (such as readability and maintainability) of the underlying code is often sacrificed because higher “quality” programming increases load time. Common optimizations include eliminating comments, using very short identifiers or variable names, and other practices that, while they may decrease load time, lead to increased difficulty in maintaining the code at a later point in time, or by developers other than the original developers.

These and other problems may be addressed by using a page resource builder (PRB) as described herein. In general, a PRB may evaluate the Web page functionality defined by a developer, and group page components together to reduce latency and bandwidth requirements for the Web page. For example, the PRB may generate a compact or optimized version of a Web page, which includes only one file or a small number of files, and includes only those functional or logical blocks required for operation of the Web page. The optimized version may also include other optimizations, such as using compact variable names to reduce the size of the Web page transmitted to the end user. However, the PRB may do so without preventing developers from further modifying the Web page, and/or without requiring a developer to modify the optimized version of the Web page directly. A development version of the Web page may leave functions un-grouped, and/or may present Web page data in a format more suitable for access and modification by a developer. Thus, embodiments of the invention may allow for development processes that make use of best-practice development techniques, such as the use of libraries or files having many functionally- or logically-related portions, significant commenting, and meaningful, human-readable variable names.

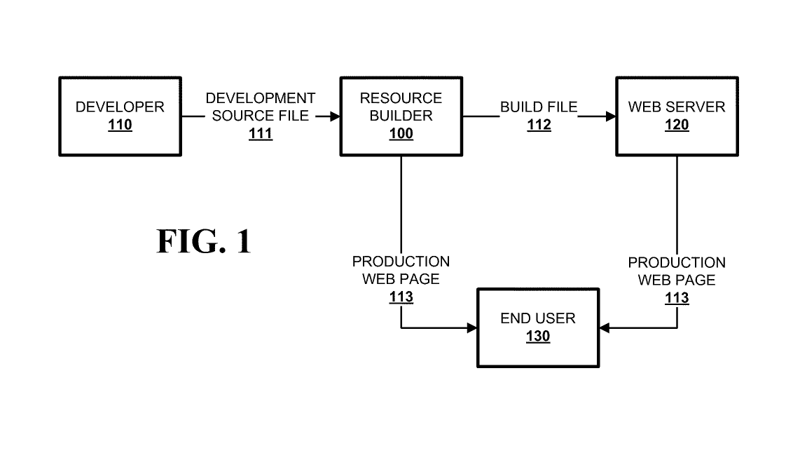

In an embodiment, the PRB may be modeled as a converter between a “development” or human-readable version of a Web page that is used by a developer to create or modify the Web page, and a “production” version of the Web page that is actually transmitted to the end user for rendering in a Web browser. FIG. 1 shows an example data flow used with a PRB according to an embodiment of the invention. A developer 110 may create and/or modify one or more development source files 111 (thereby defining or creating a “development version” of the Web page), which may be provided to a PRB 100. The development version of the Web page 111 may be referred to as “verbose,” since it may include additional comments, longer variable and function names, and other data and conventions used by a developer, but not necessary to render or implement the Web page for the end user. The PRB 100 may then translate the development source file 111 into a production version of the Web page 113 that can be provided to an end user 130, such as a computer running a Web browser or other device capable of rendering or executing the production version 113 of the Web page. Alternatively or in addition, the PRB 100 may provide a build file 112 or other item to a Web server 120 or other intermediate process. The build file 112 may be identical to the production Web page 113, in which case the Web server 120 may serve the build file/production version to the end user 130 upon receiving an appropriate request from the end user 130. Alternatively, the Web server 120 may perform additional processing on the build file 112 to prepare it for transmission to the end user 130. For example, the Web server 120 may provide caching or other functionality for files received from the PRB 100 and/or other Web pages that are provided to end users 130 upon receiving appropriate requests from the end users. In some embodiments, the PRB 100 and/or the Web server 120 may compress the build file 112 and/or the production Web page 113 to further reduce the bandwidth required to send the production Web page 113 to the end user 130.

In an embodiment, the PRB 100 may translate the development source file 111 so as to reduce or eliminate the typical latency penalty for having many relatively small, encapsulated and segmented client-side files by building all the files into one large file based on the content type of the source files. As a specific example, the PRB 100 may generate a single file for each of the JavaScript, CSS, and images for a Web page. When loaded into an end user Web browser, the Web page may incur exactly four requests from the end user to the Web server to render the Web page—one for each client-side file (JavaScript, CSS, and images), plus one for the HTML document itself. Present Web browsers typically process eight or fewer simultaneous requests per Web page. Therefore, this configuration allows such browsers to request all needed files at once, and thereby reduce or eliminate the need for the browser to await completion of earlier requests before subsequent requests can be sent to the server. As another example, the PRB 100 may generate a single file containing all the HTML, script, and style definitions required by a production Web page.

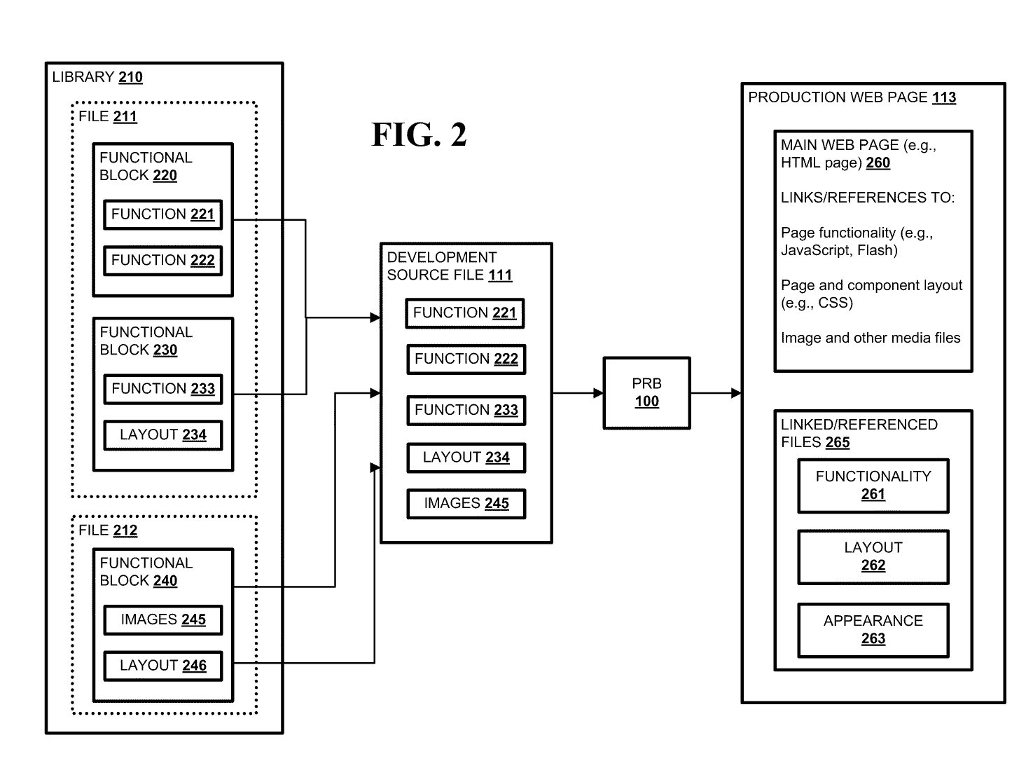

FIG. 2 shows an example data flow associated with a PRB according to an embodiment of the invention. A library 210 may include one or more files 211, 212 that include discrete blocks 220, 230, 240 of Web page functionality and/or presentation. Each functional block may include one or more components 221, 222, 233 such as JavaScript functions, layout definitions 234, 246 such as CSS definitions and attributes, or other presentation data 245 such as image files. The functional blocks 220, 230, 240 may group related or similar functionality and/or presentation together. For example, one functional block 220 may include mathematical functions, another functional block 230 may include HTML form generation and/or processing functions, such as functions to insert values into a form, functions to receive or extract data from the form based on user input, and other functions. As another example, a “process payment” block may include a library having all the code necessary to implement payment processing functionality on a production Web page. The use of a robust library including a robust set of functionality, of which only a small portion may be used for a particular Web page, can simplify development of multiple Web pages through code reuse. Such a library also may simplify the modification or extension of functions used in complex Web pages. Similarly, a library may include reusable style definitions, such as definitions describing the presentation associated with a button, paragraph, heading, or other Web page component, image files, or other types of components.

In general, functional blocks may group functionality and presentation by type, such as input, output, formatting, and display, or by any other logical grouping to aid developers in using the provided functionality. In some cases, due to the logical grouping of functionality present in the functional blocks (which can aid Web page development), some functionality may be duplicated among several functional blocks. For example, a function 221 may include some or all of the functionality present in another function 233. As a specific example, multiple functional blocks may include functionality to process user input to prepare the input for use by a backend Web server. Duplication may occur, for example, because functionality is relevant to more than one functional block, or because different functional blocks originate from different developers, library files, or other sources, each of which required the duplicated functionality, or for other reasons.

The particular files 211, 212 used to store functions, layout, and/or other style information may be referred to as source files 211, 212. Such files may include more thorough documentation, comments, and/or other descriptive identifiers than files produced by the PRB 100. Each source file 211, 212 may include one or more of functional blocks 220, 230, 240. For example, a single file 211 may include functional blocks 220 and 230, and a separate file 212 may include functional block 240 and/or other functional blocks. In a conventional Web page development system, an entire file is included in or referenced by the production Web page delivered to the end user. For example, if a production Web page includes a function 221, the entire file 211 is included, even though other functionality or functional blocks included within the file 211 are not needed by the production Web page.

According to an embodiment of the invention, a developer may create a development source file 111 that includes all the functionality necessary to create an operative production Web page 113 suitable for use by an end user. For example, the source file 111 may include or reference one or more functions 221, 222, 233, layout instructions 234, other presentation data 245 such as image files, and/or other Web page components. A developer may not use all the functionality provided by a specific functional block. For example, a functional block may provide components including functions and style definitions for creating, manipulating, and processing HTML forms. A developer may use the functional block to create a Web page that processes HTML form input received from an end user, which requires only a subset of the functionality provided by the block. For example, referring to FIG. 2, a developer may only use one functional component 221 from a functional block 220, leaving other functions 222 unused. The development source file may include only those functions actually used, or it may include each functional block and/or file that stores the functions used in the development source file 111. For example, where the function 221 is used in the source file 111, the source file 111 may include the functional block 220 and/or the entire file 211. Thus, unused functional blocks may be included in the source file 111. As a specific example, if a function 221 is used in the source file 111, the entirety of the file 211 may be included in the source file 111. Thus, another functional block 230 may be included in the source file 111 even if none of the functionality 233, 234 provided by the block 230 is used in the source file 111.

Still referring to FIG. 2, in an embodiment of the invention, the PRB 100 may process the development source file 111 to identify those Web page components used in the source file 111, and generate the production Web page 113 from the source file 111. The production Web page 113 may include multiple files, such as a main Web page 260 and a set of linked files 265 that are referenced by the main Web page 260. As a specific example, the main Web page 260 may be an HTML file that is initially loaded by an end user Web browser when the browser requests a network address associated with the main Web page 260. The linked files 265 may be, for example, JavaScript, CSS, image, or other functional, presentation, or graphic files. According to an embodiment of the invention, the PRB 100 may generate a single file 261 that includes all the functionality used in the production Web page 113, i.e., all the functionality necessary to implement functionality defined within the main Web page 260. The linked functional file 261 also may include only that functionality used in the production Web page 113. That is, unused functionality from the library 210 may be excluded from the functional file 261, even if it is included in a functional block or file that is shared with functionality which is included in the file 261. As a specific example, where a function 221 is used by the Web page but other functions 222, 233 are not, only the functions or other coding necessary to implement the function 221 is included in the file 261, even though the other functions 222, 233 may share a functional block 220 or file 211 with the included function 221. Similarly, the PRB 100 may generate a single linked file 262 that contains all the layout information for the production Web page 113, and excludes layout information not used by the production Web page 113, even if the excluded layout information is in a common functional block or file as a portion of included layout information. The PRB 100 also may generate a single linked file 263 that includes all the appearance and/or graphical data, such as images, used in the production Web page 113. As with the other linked files 261, 262, the linked appearance file 263 may include only those images or other appearance data used in the production Web page, and exclude appearance information from common functional blocks and/or files that is not used in the production Web page 113. In another embodiment, the PRB 100 may generate a single file that includes all the HTML, script functionality, style definitions, image information, or any combination thereof.

As a specific example, a production Web page 113 may include HTML, JavaScript, CSS, and images. The Web page 113 may be developed using one or more libraries 210 and development source files 111 as previously described. The development source file 111 may include or reference HTML, JavaScript functions, CSS layout information, and images from the library 210, which may be duplicated in the source file 111 due to the logical arrangement of functional blocks 220, 230, 240 within the library 210 as previously described. A PRB 100 according to an embodiment of the invention may parse the development source file 111 to identify JavaScript functions, CSS layout information, and images (collectively “components”) necessary to create the production Web page 113. The PRB 100 may then generate a main Web page 260 containing the HTML to construct the production Web page 113 and linked files 265. A single linked file 261, 262, 263 may be generated for each of the JavaScript, CSS, and images, respectively, identified by the PRB 100, and each linked file 261, 262, 263 may include only the elements needed by the production Web page 113. For example, where a single JavaScript function is included in the development source file 111 more than once, the PRB 100 may include only a single copy of the JavaScript function in the linked filed 261. In an embodiment, the linked files 265 also may include the entirety of the JavaScript, CSS, and graphics necessary to generate and operate the production Web page 113, so that no other files are required or referenced by the production Web page 113.

In an embodiment, a library 210 or other source file 111 includes metadata to identify functions, style definitions, or other code blocks that can be extracted, manipulated, and combined into one or more files for a production Web page, such as the linked files 265 previously described. An example excerpt of such a library file in pseudocode is shown below:

```
/* PRB:
      PRB_function: getValue
      PRB_deps: isDefaultValue isArray
*/
function getValue( ) {
      userInputText = form.value
      store(userInputText)
      . . .
}
/* /PRB */
/* PRB:
      PRB_function: isDefaultValue
      PRB_deps: getFormControl
/*
function isDefaultValue( ) {
      if userInputText = defaultValue {return true} else {return
false}
}
/* /PRB */
```

The example above shows functions, such as JavaScript functions, that may be used in a library file. As another example, a library may include style definitions as shown below:

```
/* PRB:
      PRB_style: mainForm
      PRB_defs: body
/*
mainForm {
      margin-left: 20px;
      margin-top: 10px;
      background: #FFFF88;
      font-size: 1.2em;
      font-weight: bold;
}
/* /PRB */
```

Similar structures may be used for images or other appearance information related to the Web page. As will be understood by one of skill in the art, a library or other source file may include any number of functions, style definitions, and other types of information. As shown in the examples above, metadata may be stored in comment sections of the library file, and may include opening and closing metadata “tags” to separate each function, style definition, or other individual segment from other segments of the file. In the specific examples shown, the opening tag is “PRB:” and the closing tag is “/PRB,” but any tag or tag structure may be used. The metadata also may include tags to indicate the name of a function, style definition, or other component contained in the PRB block, any dependencies necessary for the component, and/or other information about the component. For example, the “getValue” block shown in the example excerpt above includes metadata to indicate that the corresponding PRB block includes a function named getValue (“PRB function: getValue”), which depends on two other functions, is DefaultValue, and is Array. The function definition then appears between the opening and closing PRB tags. Operation of these blocks for other functions, style definitions, or other components will be readily apparent to one of skill in the art.

The example above illustrates a divisible library having distinct, divisible functionalities that includes multiple PRB blocks. Metadata may also be inserted to an indivisible library having a specific, indivisible functionality, to define appropriate dependencies for the library as a whole. An example of pseudocode for an indivisible library, such as a style file, with metadata “tags” follows:

/* PRB:
PRB_style: /path/to/file/directory/my_styles.css
PRB_defs: base_file, body
*/
... (file contents) ...
/* /PRB */

In an embodiment, a developer may identify those segments of a library 210 that are used in one or more development source files 111, for example by creating a list that includes a list of component names used in the source files 111, or other metadata that corresponds to the necessary segments and/or files. The developer may specify each component used, or a developer may only identify parent-level blocks (i.e., blocks with no dependencies) and/or files directly related to the development source file. In an embodiment, this list also may be automatically generated, such as by a program that parses the development source file and identifies each component used therein. This process may be performed by the PRB 100, or by another process.

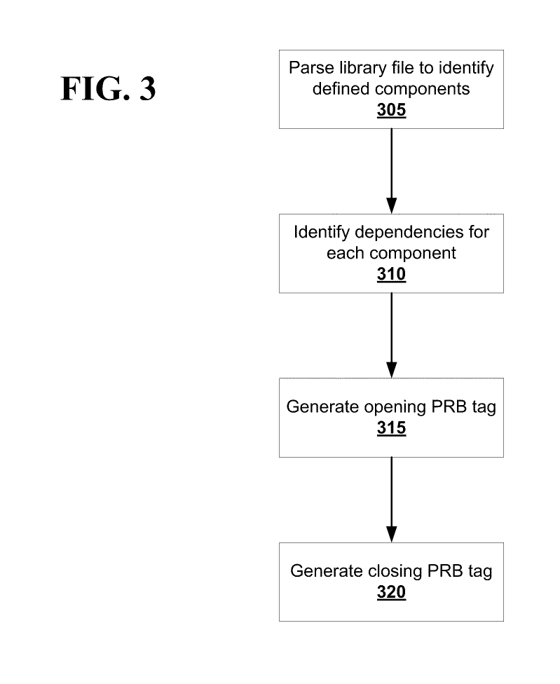

The tags may be used by the PRB 100 according to embodiments of the invention in various ways. For example, the PRB 100 may parse one or more development source files 111 to recursively identify components that are required due to dependencies of listed components, and include those components into a build file and/or a production Web page 113. FIG. 3 shows an example computer-implemented process for automatically adding PRB tags to one or more files 211, 212 within a library 210. At 305, the PRB 100 or another computer process may parse the files 211, 212 to identify functions, style definitions, images, or other Web page components defined by the library 210. At 310, for each component identified, the component may be parsed to identify any dependencies for the component. For example, a function may be parsed to determine whether it includes calls to other functions in the library 210. At 315, the process may generate an opening PRB tag that identifies the name of the component, component dependencies, and any other information used by the PRB 100. For example, the process may list the name of a function, style definition, or image file as the title of the component. The process also may list any dependencies identified for the component in the opening PRB tag. At 320, the process may identify the end of the component and place a closing PRB tag in the file 211, 212 to mark the end of the component. As previously described, these tags may be used by a PRB 100 to identify and manipulate components used in a production Web page 113. This process may be repeated until each component in a specific file 211, 212 within the library 210 has been parsed, and/or each file 211, 212 in the library 210 has been parsed to identify components.

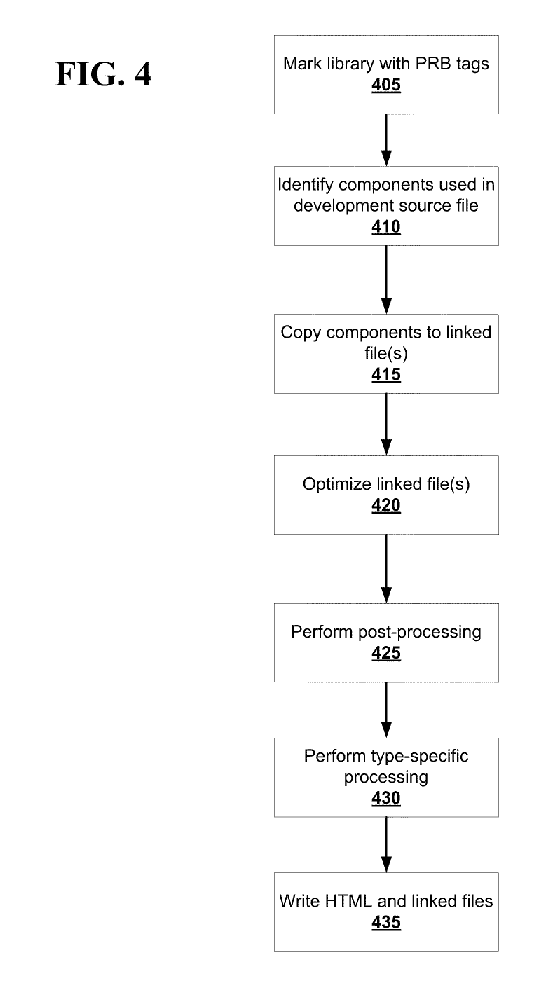

FIG. 4 shows an example process for using a PRB 100 according to an embodiment of the invention. At 405, a library 210 may be marked with PRB tags to identify function, style, or other individual components that may be used in a production Web page 113. As previously described, the tags may be added manually by the developer 110, or they may be added automatically by the PRB 100, a pre-processor, or other computer-implemented process, such as the process described with respect to FIG. 3. At 410, the PRB 100 may parse one or more development source files 111, read a list constructed by the developer 110, or otherwise identify the components used in the development source file 111 and, therefore, required by the production Web page 113. For example, the PRB 100 may parse the development source file 111 to identify PRB blocks used in the development source file 111, such as by identifying the corresponding PRB tags. As another example, the PRB 100 may use a programmatic Web browser, such as a model Web browser process that does not produce end-user-visible output, to load the development Web page. The PRB 100 may then identify the loaded development version 111 of the production Web page 113 to identify the files 211, 212 and component names required for the production Web page 113.

At 415, the PRB 100 may copy the identified components from the library 210 and/or the development source file 111 to the appropriate linked files 265. As previously described, the production Web page 113 may include a single linked file 261, 262, 263 of each type, and each component may be copied only into the linked file 261, 262, 263 of the appropriate type. Thus, for example, the production Web page 113 may include a single linked script file, which includes all the script functionality necessary for the production Web page 113, and only the script functionality necessary for the production Web page 113.

At 420, the PRB 100 may optimize each linked file 261, 262, 263. The optimization process may include concatenation, white space removal, metadata and/or comment removal, or any combination thereof, as well as other techniques as will be appreciated by one of skill in the art. It will be understood that although such a process is often referred to as “optimization,” the resulting file may not be optimal according to any arbitrary measure, though it may be considered optimal according to one or more metrics defined within the system. As a specific example, the PRB 100 may remove unnecessary whitespace from the files to reduce the size of each file. At 425, the PRB 100 may perform additional processing of one or more of the linked files 265, such as obfuscation, compression, combinations thereof, and other similar processing as will be understood by one of skill in the art. For example, the PRB 100 may rename descriptive variables as used in the development source files 111 to smaller and less-descriptive names. At 430, the PRB 100 may perform additional type-specific processing on one or more of the linked files 265. For example, additional metadata may be generated for use by an end-user Web browser when processing the production Web page 113. As a specific example, the PRB 100 may concatenate multiple images into a single image file and generate a CSS that defines CSS sprites within the concatenated image file. As another specific example, the PRB 100 may identify text needed for translation, and include appropriate metadata to assist with the translation. The PRB 100 may generate original material. For example, the CSS sprite information, translation information, and other generated data may be created by the PRB 100, and may not appear in any library 210 or development source file 111.

At 435, the PRB 100 may write the main HTML file 260 and/or each of the linked files 265 to local, network, or other storage, for example to be served to a Web browser in response to a request received from an end user 130. As will be understood by one of skill in the art, an appropriate reference to each linked file 261, 262, 263 may be included in the main HTML file 260. Thus, an end user Web browser may be able to retrieve the production Web page 113 by requesting the main HTML file 260 and, responsive to the appropriate tags or other information in the main HTML file 260, requesting each of the linked files 265. In various embodiments, the Web browser may be able to obtain the entire production Web page using only 1, 2, 3, or 4 requests to the Web server 120.

In an embodiment, a PRB 100 may be integrated into an interpreter that executes the Web page 113 as a user's browser would to determine which dependent components are really necessary. Such a configuration may be used instead of explicit marking and identification, by a Web-page developer, of files and components to be included, such as dependent functions. This may avoid or reduce the occurrence of dependent components being incorporated that are not used in the production Web page 113, but are mistakenly indicated as such in parent metadata. For example, while pages that include too few resources likely will be identified because they will break when developed or tested, pages that include too many resources normally will not be so identified or detected. Using the interpreter to identify required components may provide a mechanism for eliminating dependence upon a developer to indicate the required components, which may thereby assure that only the exact set of required functionality is included in the built Web page file, i.e., there is no extraneous functionality present, and no required functionality missing.

According to embodiments of the invention, the files associated with a production Web page 113 may be larger than the equivalent files that would be used in the absence of the PRB 100. However, there generally are fewer total files, which may result in a reduction of the latency penalty and often a reduction in the loading time of the production Web page 113, especially for complex pages. A PRB 100 also may use built-in or third-party components to compress the Web page code, reducing file size further. This may improve the user experience by reducing the bandwidth penalty associated with each file served for loading the Web page. Together these changes may reduce overall bandwidth costs incurred with serving the Web page since there are fewer requests, and the total data returned from each server request are smaller due to compression.

In some embodiments, a PRB 100 may construct different build files and/or production Web page files 113 based on a one or more defined user agent (Web browser) profiles. If a site supports multiple browsers that require different coding to create distinct or mutually compatible user experiences, the PRB may be configured to programmatically load each version of the page and build separate, browser-specific build files based on the data received. For Example, a one-time configure file can designate which page to load with which browser. An example of psuedocode of a browser designation within a configure file follows:

```
/* PRB:
  PRB_browser_id: ff2
  PRB_browser_agent_string: Mozilla/5.0 (Windows; U; Windows
NT 5.1; en-US; rv:1.8.1.16; Gecko/20080702 Firefox/2.0.0.16
*/
/* PRB:
  PRB_browser_id: ie7
  PRB_browser_agent_string: Mozilla/4.0 (compatible; MSIE 7.0;
Windows NT 5.1; .NET CLR 2.0.50727; .NET CLR 1.1.4322;)
*/
```

It will be appreciated that the configure file may designate as many browsers as appropriate. These configurations may be applied for all built pages, or a subset of built pages as needed.

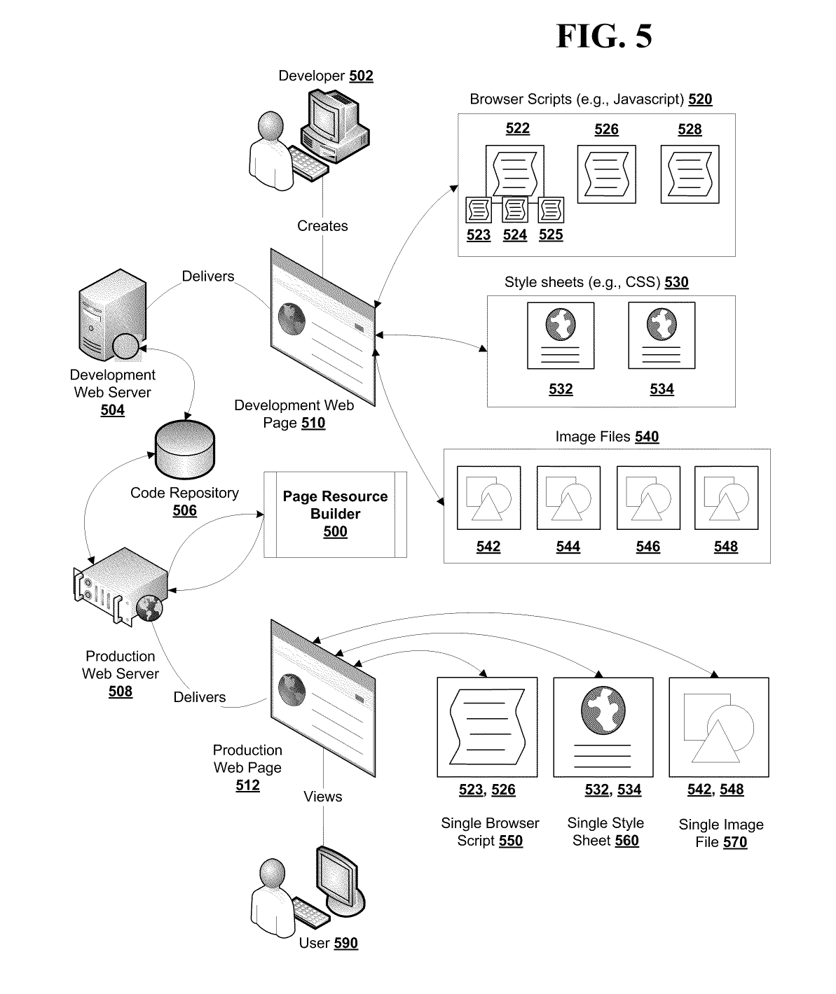

FIG. 5 shows a specific example of a system and data flows according to an embodiment of the invention. A developer 502 may create a development Web page 510 using one or more components or component libraries 520, 530, 540. The libraries 520, 530, 540 may contain scripts 522, 526, 528 such as Javascript, style definitions 532, 534 such as CSS, images 542, 544, 546, 548, and other components. Components may link to or include other components, such as scripts 523, 524, 525. For example, an individual Javascript library 520 may include multiple components that can be used independently by the developer 502. The developer 502 may use some, all, or none of the components in the individual library 520 to generate data to construct a desired production Web page 512, though the development Web page 510 may include additional non-required components. For example, a developer may desire the production Web page 512 to include functionality or appearance defined in script components 523 and 526, style components 532 and 534, and images 542 and 548, as depicted by files 550, 560, and 570, respectively. The development Web page 510 may further include script components 522 (which includes component 523) and 526, style sheet 530 (which includes CSS definitions 532 and 534), and image library 540 (which includes images 542 and 548). For example, entire libraries or hierarchies of files may be included in or referenced by the development Web page 510 to simplify development (or modification) of the production Web page 512.

The development Web page 510 may be stored or hosted by a development Web server 504 and/or code repository 506. Typically, a code repository 506 may contain development files that may be incorporated into the development Web page 510, which may be served by the development server 504 as will be understood by one of skill in the art.

A page resource builder (PRB) 500 as previously described herein may receive the development web page 510 and/or other source files, such as directly or indirectly from the development web server 504, a production web server 508, or other mechanism. The PRB 500 may then generate a production web page 512 as previously described, which may be delivered to an end user 590 by the production web server 508.

The production Web page 512 may include or link to various other files 550, 560, 570. For example, the production Web page 512 may be a relatively sparse HTML file, which then links to a script file 550, style sheet 560, and image file 570. As previously described, each of these files may include only the script, style, and image data, respectively required to render or operate the production Web page 512, and/or may include all of the script, style, and image data necessary to properly render or operate the Web page 512. For example, the browser script file 550 may include script components 523 and 526, and may include only those components. Similarly, a single style sheet 560 may include style definitions 532 and 534, and a single image file 570 may include images 542 and 548. Components may be grouped differently within each file. For example, specific code in the browser script file 550 may be grouped according to functionality. As another example, the images 542, 548 may be combined into a single image file, and CSS generated to define the location of each image within the file. The generated CSS may be included in the single style sheet 560, or may be provided separately. Other groupings and configurations may be used.

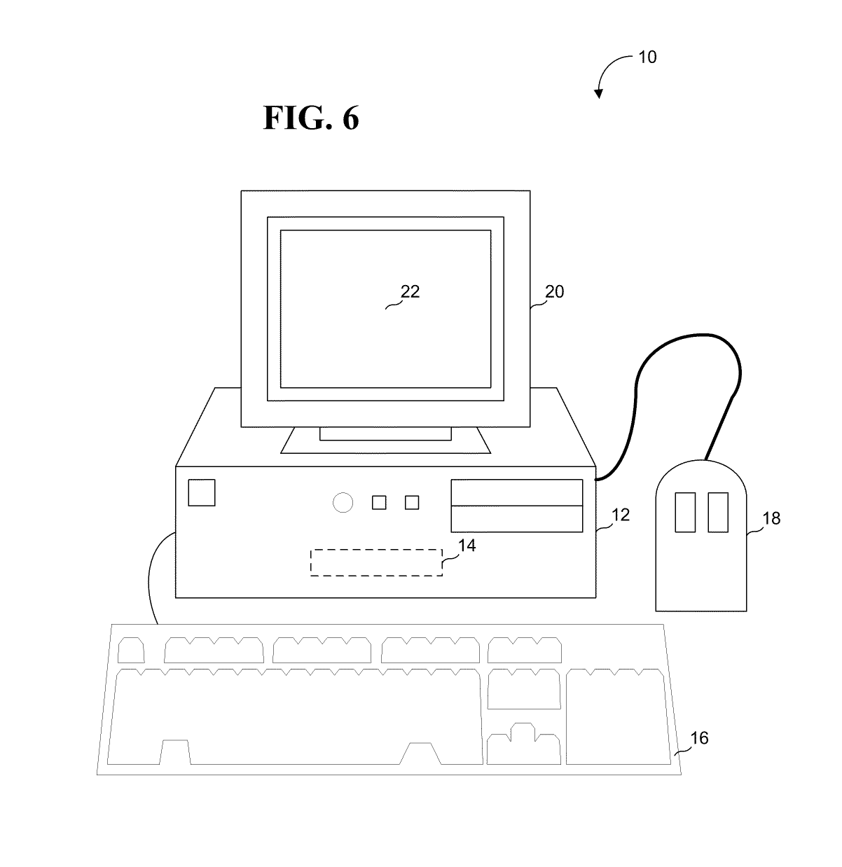

FIG. 6 shows a computer suitable for use with embodiments of the present invention. The computer 10 may include a processing unit 12, which may include one or more computer readable storage media 14. The computer may interface with a human operator via an output 20, which may include a visual display 22 to display text, graphics, video, and other visual data. The computer may receive input via a mouse 18, keyboard 16, and/or any other suitable user interface. The general operation of the computer 10 will be understood to one of skill in the art.

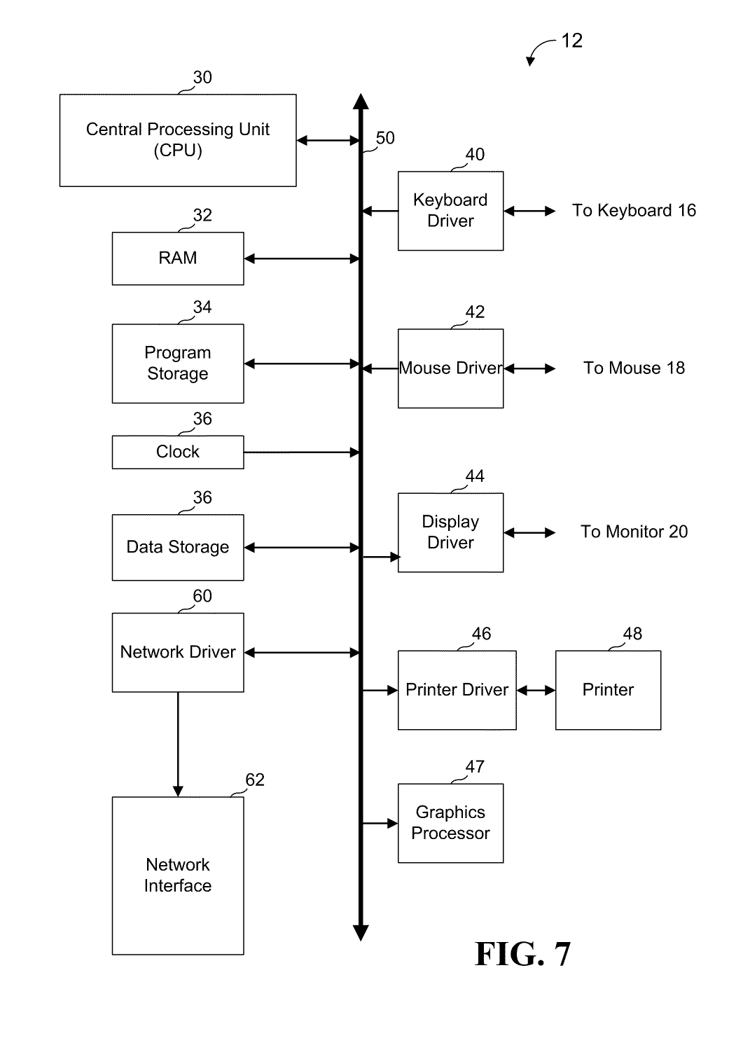

FIG. 7 shows a schematic diagram of the processing unit 12. A central processing unit 30 may communicate with various other components via a main bus 50 and other suitable communication lines (not shown). Data may be stored in volatile memory such as RAM 32, program storage 34 and/or data storage 36. The program storage 34 and/or data storage 36 may include various types of computer-readable media, such as CD-ROMs or other type of optical disks, floppy diskettes, ROMs, RAMs, EPROMs, EEPROMs, magnetic or optical cards and drives, flash memory, or other types of machine-readable mediums suitable for storing electronic instructions. Computer-readable instructions may be stored in the program storage 34. When executed by the computer, these instructions may cause the computer to implement specific methods as described herein, and may cause the computer to operate in accordance with those methods. In an embodiment, execution of the instructions stored in the program storage 34 may transform a general-purpose computer into a computer configured to perform one or more methods embodied by the instructions. A clock 35 may be used to synchronize operation of the other elements of processing unit 12. A network driver 60 may manage connections between a network interface 62, such as a TCP/IP or other suitable interface, to allow the computer to communicate with other computers, operators, or other entities. A keyboard driver 40 may communicate with the keyboard 16 to receive input from an operator. A mouse driver 42 may manage communication with the mouse 18 to coordinate reception of input signals. A display driver 44 may manage communications between the processing unit 12 and the monitor 20, such as to display appropriate output on the monitor 20. Similarly, a printer driver 46 may manage communications with a printer 48. A graphics processor 47 may generate and manage manipulation and display of graphical elements such as 2D images, 3D images and objects, and other visual elements. The general operation of the various components shown in FIG. 6 otherwise will be understood by one of skill in the art.

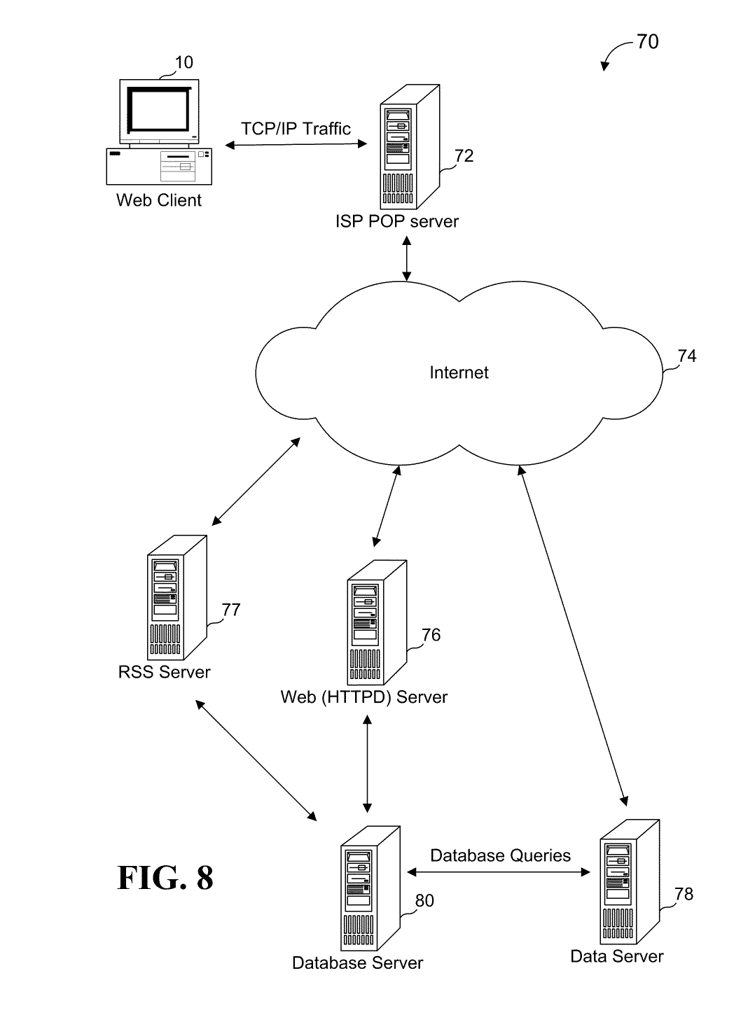

FIG. 8 shows an example of a computer network 70 suitable for use with the present invention. A client such as the computer 10 may access the Internet or other network via a point of presence server 72 or other server, such as provided by an ISP. The computer 10 may access various servers, such as a Web or HTTP server 76, an RSS server 77, or other suitable server or other information provider. As previously described, the various computers 10, 76, 77 may communicate with one or more databases 80 or other data servers 78 to retrieve information. The general operation of the network 70 and the various components shown in FIG. 8 otherwise will be understood by one of skill in the art.

An embodiment of the invention may be embodied in the form of computer-implemented processes and apparatuses for practicing those processes. Embodiments also be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method comprising:
identifying components within a Web page source file, each component being a script function, a style definition, or an image;
for each identified component, generating an opening tag for the component, the opening tag identifying a name of the component and any other components on which the identified component depends, and modifying the Web page source file to include the opening tag at a location preceding a beginning of the component;
for each identified component, generating a closing tag for the component, and modifying the Web page source file to include the closing tag at a location following an end of the component;
identifying components within a development source file used to generate a production Web page, the development source file providing a development version of the production Web page;
for each component identified in the development source file:
(1) selecting a linked file based on whether the component is a corresponding script function, style definition, or image, the linked file being used during rendering of the production Web page; and
(2) copying the component from the Web page source file to the selected linked file;
generating a main Web page file containing hypertext markup language (HTML) to render the production Web page and a link to each of the linked files to which a component is copied; and
responsive to a request for the production Web page, providing the main Web page file to a Web browser of an end user.

2. The method of claim 1, wherein the Web page source file comprises a library.

3. The method of claim 1, wherein the Web page source file comprises the development source file.

4. The method of claim 1, wherein a set of selected linked files includes a script file consisting essentially of the script functions required by the production Web page.

5. The method of claim 1, wherein a set of selected linked files includes a style definition file consisting essentially of the style definitions required by the production Web page.

6. The method of claim 1, wherein the identified components used to generate the production Web page comprise a plurality of images, the method further comprising:
generating a single image file containing each of the plurality of images identified in the development source file;
generating a style definition indicating a location of each image within the single image file; and
adding the generated style definition to the linked file selected for style definition components.

7. The method of claim 6, wherein the selected linked file corresponding to style definition components contains all of the style information required to render the production Web page.

8. The method of claim 7, wherein the selected linked file corresponding to style definition components consists essentially of style information required to render the production Web page.

9. The method of claim 1, wherein a set of selected linked files consists of a script function file, a style definition file, and an image file.

10. The method of claim 9, wherein the main Web page file and the set of selected linked files contain all the HTML, script, style, and image data required to render the production Web page.

11. The method of claim 10, wherein the set of selected linked files consist essentially of the script, style, and image data required to render the production Web page.

12. The method of claim 1, further comprising the step of, responsive to at least one request from the end user Web browser, providing a selected linked file.

13. The method of claim 1, wherein the production Web page is provided to the end user Web browser in response to no more than four requests.

14. A computer-implemented method comprising:
identifying resource tags within a development source file, the development source file providing a development version of a production Web page, each resource tag identifying a component used to generate the production Web page;
for each identified resource tag:
(1) identifying the corresponding component used to generate the production Web page;
(2) identifying a type of the identified component;
(3) copying each identified component from the development source file to a linked file designated for components of a same type as the identified component, the linked file providing all the components of a single type required to render the production Web page;
generating a main Web page file containing hypertext markup language to render the production Web page and a link to each linked file to which a component is copied; and
responsive to a request for the production Web page, providing the main Web page file to a Web browser of an end user.

15. The method of claim 14, wherein a set of linked files to which components are copied comprises:
a first linked file containing all the script components required to render the production Web page; and
a second linked file containing all the style definitions required to render the production Web page.

16. The method of claim 15, wherein the set of linked files to which components are copied further comprises a third linked file containing all the images required to render the production Web page.

17. The method of claim 15, wherein the first linked file consists essentially of script components required to render the production Web page, and the second linked file consists essentially of style definitions required to render the production Web page.

18. The method of claim 17, wherein the set of linked files to which components are copied further comprises a third linked file consisting essentially of all the images required to render the production Web page.
